(19) United States
(12) Patent Application Publication
(10) Pub. No.: US 2026/0177182 A1
(43) Pub. Date: Jun. 25, 2026

(54) Damping Device

(71) Applicant: Hydac Technology GmbH, Sulzbach / Saar (DE)

(72) Inventors: Peter Kloft, Ransbach-Baumbach (DE); Torsten Kusserow, Thörnich (DE)

(73) Assignee: Hydac Technology GmbH, Sulzbach / Saar (DE)

(21) Appl. No.: 18/855,106

(22) PCT Filed: Mar. 24, 2023
(86) PCT No.: PCT/EP2023/057614

§ 371 Date: Oct. 8, 2024

(30) Foreign Application Priority Data
Apr. 9, 2022 (DE) 10 2022 001 220.0

(51) Int. Cl. F16L 55/04

(52) U.S. Cl. CPC F16L 55/043

(57) ABSTRACT

The invention relates to a damping device, in particular for damping or preventing pressure surges, such as pulsations, in fluid supply circuits, for example in the form of a silencer, having a damping housing and a damping tube running in the damping housing, which has an inlet and an outlet for the fluid flow to be damped, and having at least one branch opening, which produces fluid-conducting connection between the interior of the damping tube and a damping volume enclosed between the damping tube and the damping housing, wherein each branch opening has a tubular connection part of predeterminable length and diameter, which opens into the damping volume.

### CROSS-REFERENCE TO RELATED APPLICATIONS

This application claims priority to German Patent Application No. DE 10 2022 001 220.0, filed on Apr. 9, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a damping device, in particular for damping or preventing pressure surges, such as pulsations, in fluid supply circuits, for example in the form of a silencer, having a damping housing and a damping tube running in the damping housing, which has an inlet and an outlet for the fluid flow to be damped, and having at least one branch opening, which creates a fluid-conducting connection between the interior of the damping tube and a damping volume enclosed between the damping tube and the damping housing.

DE 10 2015 000 418 A1 discloses a damping device with a damping housing surrounding a damping chamber, said housing comprising at least one fluid inlet and one fluid outlet and a damping tube located in the flow path between the inlet and the outlet, said damping tube comprising at least one branch opening engaging through the tube wall leading to a Helmholtz volume inside the damping housing in order to form a Helmholtz resonator in a region located within its length, wherein a fluid filter is arranged in the flow path running between the fluid inlet and the fluid outlet inside the damping housing. Integrating the fluid filter in the damping housing makes for a particularly compact construction while simultaneously increasing operating reliability by omitting connecting pipework which would otherwise be required between a filter and a damper.

### SUMMARY

Based on this prior art, a need exists to provide a damping device with improved properties.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example damping device in its entirety on a smaller scale and in a perspective view; and

FIG. 2 shows an enlarged longitudinal section through the damping device according to FIG. 1.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

By virtue of the fact that, according to some embodiments, each branch opening has a tubular connection part of predeterminable length and diameter, which opens into the damping volume, individual tube sections are created which damp the fluid passing through said sections as bodies that are able to vibrate. For example, in this case, the longitudinal axis of each tubular connection part is perpendicular to the longitudinal axis of the damping tube, the orientation of which determines the main flow direction for the fluid passing through the damping tube.

In particular, the respective branch opening in the damping tube transitions seamlessly into the inner chamber of the tubular connection in this case and the geometry of the branch opening is continued in the abutting connection part. For example, in this case the respective tubular connection part transitions in one piece and seamlessly into the damping tube in the region of the assigned branch opening and all components of the damping device in the form of the damping housing, the damping tube and the branch openings plus the assigned tubular connection parts are integrated in one component. The aforementioned structural components can accordingly be quickly adjusted to these in a simple manner as a function of the actual conditions, which helps save manufacturing costs.

In some embodiments of the damping device, it is provided that a plurality of branch openings with their respective assigned tubular connection parts engage through the damping tube and that each individual frequency of the fluid flow to be damped is assigned to a specially configured connection part. In this manner, the frequency to be damped can be adjusted via the diameter and length of the respective tubular connection part such that a kind of multi-Helmholtz resonator arises accordingly. However, in order to damp a frequency range, a row of connection parts of the same or different type arranged side-by-side is beneficial. An opening in the damping tube therefore damps a frequency and a plurality of openings with a different cross-section damp a frequency range.

For example, in this case it is provided that at least some of the connection parts used are geometrically different from one another, for example that all connection parts are different from one another. If all connection parts are configured differently in terms of their geometry, efficient damping can be achieved in a very wide frequency spectrum of the vibrations arising in the fluid flow in the damping tube. In this case, as a rule, a plurality of connection parts, in particular for high and low frequencies, can be provided inside the damping device, which, under certain circumstances are not required at all for a specific application; however, they may well be required in a different application, in which case the tubular connection parts provided for medium frequency ranges are not required in this instance.

Accordingly, the connection parts with a small inner diameter and a long length are better suited to damping low frequencies in the fluid flow than connection parts with a large inner diameter and short structural length, which are for example responsible for damping high frequencies.

To improve the damping effect when high pressure pulsations arise in the fluid flow, it may for example be provided that the wall thickness of the damping housing is reinforced with respect to the wall thickness of the damping tube.

If a plurality of connection parts with different configurations are arranged in a row along the damping tube while retaining discrete distances from one another, which are for example the same, and a further row with connection parts is provided on opposite sides of the damping tube next to the first row, reliable damping can be achieved to a great extent in connection with a very broad frequency spectrum for the fluid with a low natural vibration behaviour of the damping tube. In this case, with regard to the desired vibration behaviour, it has proven favourable to configure the number of connection parts in one row such that it is different from the number of connection parts in the further row.

In some embodiments of the damping device, it is provided that the damping housing and the damping tube with its connection parts are formed in one piece by means of an additive manufacturing process, which makes it possible to adjust the structural size of the damping device to a plurality of applications with low manufacturing costs without having to deviate from the basic design of the damping device. This therefore has no parallel in the prior art.

In some embodiments of the damping device, it is provided that the damping volume delimited by the damping housing and the damping tube is configured to be toroidal with a larger longitudinal extension viewed parallel to the possible fluid flow direction than transversely thereto. Particularly in the region of the deflection points in the damping housing, i.e., in the region of the inlet and outlet of the damping tube, a uniform flow guidance arises for the fluid admitted to the damping chamber via the tubular connection parts, which increases the overall damping capacity for the damping device.

The damping device is discussed below with the aid of an example of an embodiment with reference to the drawings. Specific references to components, process steps, and other elements are not intended to be limiting. Further, it is understood that like parts bear the same or similar reference numerals when referring to alternate FIGS.

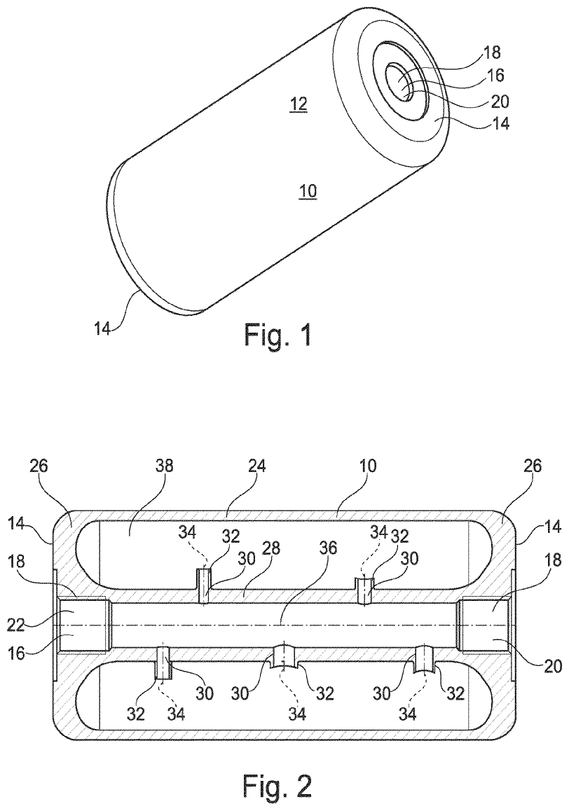

FIG. 1 shows the damping device in its entirety on a smaller scale than shown in FIG. 2 and in a perspective external view. The cylindrical damping housing 10 is formed with a smooth external wall 12 to the outside and constructed symmetrically. Towards the free end faces of the damping housing 10, the external wall 12 terminates in a curved, rounded manner in an end closure wall 14, through which a central mid-opening 16 passes with a received female threaded part 18, which serves to connect a pipe, which is not shown in greater detail, which supplies a fluid flow to be smoothed or damped as part of a fluid supply circuit, said fluid flow thus being free from pressure surges, such as pulsations, and passing out of the damping housing 10 opposite once again. In this process, as viewed on the FIGS., the right-hand mid-opening 16 forms the fluid inlet 20 for the fluid flow and the mid-opening 16 thus formed in the same manner on the left-hand side serves as the fluid outlet 22, via which the fluid flow is passed out of the damping housing 10 once again. With regard to the axially symmetrical structure of the damping device in its entirety, however, it is also possible to reverse the throughflow direction such that fluid flows in via the outlet 22 and out of the damping housing 10 via the inlet 20.

As is shown by FIG. 2 in longitudinal section in particular, the damping housing 10 has a middle cylindrical wall section 24 with a consistent wall thickness and this wall section 24 transitions at its ends in the direction of the respective end closure wall 14 into a kind of cover part 26 with a comparatively larger wall thickness. A cylindrical damping tube 28 runs in the damping housing 10 in its entirety, said damping tube transitioning at its ends into an assigned cover part 26 in each case and. at the free end faces, the damping tube 28 opens into the respective female threaded part 18, which is thus received in the respective cover part 26. In its middle receiving region, the damping tube 28 in each case has a wall thickness that is selected to be somewhat larger than the wall thickness along the cylindrical wall section 24 of the damping housing 10. In this manner, the damping tube 28 is also connected to the inlet 20 and to the outlet 22 of the damping housing 10. As is also shown on FIG. 2, individual through branch openings 30 with a predeterminable inner diameter are made in the damping tube 28. Individual tubular collection parts 32 are connected to the respective branch opening 30, for example in one piece with the damping tube 28, the axial structural length of said connection parts being predeterminable, although their inner diameter is adjusted to the inner diameter of the respective branch opening 30.

As is also shown on FIG. 2, the individual longitudinal axes 34 of the branch opening 30 and the assigned connection part 32 are perpendicular to the central axis 36 of the damping tube 28, along which the fluid flow to be damped passes from the inlet 20 in the direction of the outlet 22. In this manner, this leads to a sharp right-angle deflection of the fluid flow originating from the damping tube 28 in the direction of the respective outlet of a tubular connection part 32 to a damping volume 38, which is located between the damping tube 28 and the damping housing 10 on the inner circumference. As such, each connection part 32 thus forms a fluid-conducting tube connection between the inside of the damping tube 28 and the thus designated damping volume 28, in which fluid flows accordingly from the damping tube 28 during operation of the damping device.

As such, a plurality of branch openings 30 with their respective assigned tubular connection parts 32 thus engage through the damping tube 28 and each frequency range or each individual frequency of the fluid flow is assigned to a specially configured connection part 32, which is thus designed to be a different length and, together with the assigned branch opening 30, delimits a discrete diameter for fluid branching from the main fluid flow in the damping tube 28. for example, in this process, as shown on FIG. 2, it is provided that all connection parts 32 with their branch openings 30 are geometrically different from one another so as to thus allow a wide frequency range of fluid pulsations to be damped or smoothed respectively. In this case, tests have shown that connection parts 32 with a small inner diameter and longer length damp low frequencies of the fluid flow better than connection parts 32 with a large inner diameter and a short structural length, which are primarily responsible for damping higher frequencies. Furthermore, to improve the damping effect when high pressure pulsations arise in the fluid flow, the wall thickness of the tubular connection parts can be reinforced with respect to the wall thickness of the damping tube 28. However, in the present embodiment, for damping purposes it is provided that the wall thickness of the tubular connection part 32 is configured to be thinner than the wall of the damping housing 10 and that of the damping tube 28. As such, however, the selected wall thickness for all connection parts 32, as used in the damping housing 10 shown in FIG. 2, is configured to be the same with respect to wall thickness.

Furthermore, it has proven beneficial for the damping effect if a plurality of connection parts 32 with a different configuration are arranged in a row along the damping tube 28 while retaining discrete distances from one another, which are for example the same. Thus, as viewed on FIG. 2, the damping tube 28 has two connection parts 32 along with associated branch openings 30 in the damping tube 28 on its upper side. Opposite thereto, the damping tube 28 has a further row with connection parts 32 on the opposite underneath side, this time in the form of three connection parts 32 along with assigned branch openings 30.

The damping volume 38 delimited by the damping housing 10 and the damping tube 28 is configured to be toroidal, i.e. in the transition region between the cylindrical wall section 24 and the cover parts 26, the inner wall of the damping housing 10 is configured such as to form a torus-like fluid chamber for the damping volume 38 and the annular, concave receiving regions thus formed in the cover part 26 enable the damping effect for the fluid to be improved still further.

The damping device shown in the FIGS. is manufactured in one piece thanks to an additive manufacturing process, for example as part of a selective laser sintering process from metallic material. The corresponding additive manufacturing process is only mentioned by way of example and other appropriate 3D manufacturing methods can be used in this case. As such, the damping housing 10 and the damping tube 28 along with all its connection parts 32 are therefore manufactured in one piece and the two connections in the form of the female threaded sections 18 enable the silencer to be manufactured to be constructed and positioned in a particularly simple manner inside the manufacturing chamber of the additive manufacturing machine. In this manner, the middle damping tube 28 with the tubular connection parts 32 to be attached at the respective branch opening 30 can be obtained in a particularly favourable manner.

The tubular connection parts 32 are configured as hollow cylinders with a for example circular passage cross-section. By virtue of the 3D method, the circular shape can, however, also be approximated by a polygon.

Overall, by means of the additive manufacturing process, a damping device in its entirety is obtained which, with regard to its structural dimensions along with all its components, can be adapted to a plurality of applications in a cost-effective manner. This therefore has no parallel in the prior art.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A damping device, having a damping housing and a damping tube running in the damping housing, which has an inlet and an outlet for the fluid flow to be damped, and having at least one branch opening, which creates a fluid-conducting connection between the interior of the damping tube and a damping volume enclosed between the damping tube and the damping housing, wherein each branch opening has a tubular connection part of predeterminable length and diameter, which opens into the damping volume.

12. The damping device of claim 11, wherein a plurality of branch openings with their respective assigned tubular connection parts engage through the damping tube and wherein each individual frequency to be damped or each frequency range of the fluid flow to be damped is assigned to a specially configured connection part or a row of connection parts respectively.

13. The damping device of claim 11, wherein at least some of the connection parts used are geometrically different from one another.

14. The damping device of claim 11, wherein the connection parts with a small inner diameter and longer length damp low frequencies of the fluid flow better than connection parts with a large inner diameter and a short length, which are responsible for damping higher frequencies.

15. The damping device of claim 11, wherein, to improve the damping effect when high pressure pulsations arise in the fluid flow, the wall thickness of the damping housing is configured to be reinforced with respect to the wall thickness of the damping tube.

16. The damping device of claim 11, wherein a plurality of connection parts with a different configuration are arranged in a row along the damping tube while retaining discrete distances from one another.

17. The damping device of claim 11, wherein a further row with connection parts is provided on opposite sides of the damping tube in addition to the first row.

18. The damping device of claim 11, wherein the number of connection parts in one row is different from the number of connection parts in the further row.

19. The damping device of claim 11, wherein the damping housing and the damping tube is manufactured as one piece with its connection parts using an additive manufacturing process.

20. The damping device of claim 11, wherein the damping volume delimited by the damping housing and damping tube is configured to be toroidal with a larger longitudinal extension viewed parallel to the fluid flow direction than transversely thereto.

21. The damping device of claim 11, configured for damping or preventing pressure surges in fluid supply circuits.

22. The damping device of claim 11, configured in the form of a silencer.

23. The damping device of claim 12, wherein at least some of the connection parts used are geometrically different from one another.

24. The damping device of claim 13, wherein all connection parts are different from one another.

25. The damping device of claim 23, wherein all connection parts are different from one another.

26. The damping device of claim 12, wherein the connection parts with a small inner diameter and longer length damp low frequencies of the fluid flow better than connection parts with a large inner diameter and a short length, which are responsible for damping higher frequencies.

27. The damping device of claim 13, wherein the connection parts with a small inner diameter and longer length damp low frequencies of the fluid flow better than connection parts with a large inner diameter and a short length, which are responsible for damping higher frequencies.

28. The damping device of claim 12, wherein, to improve the damping effect when high pressure pulsations arise in the fluid flow, the wall thickness of the damping housing is configured to be reinforced with respect to the wall thickness of the damping tube.

29. The damping device of claim 13, wherein, to improve the damping effect when high pressure pulsations arise in the fluid flow, the wall thickness of the damping housing is configured to be reinforced with respect to the wall thickness of the damping tube.

30. The damping device of claim 14, wherein, to improve the damping effect when high pressure pulsations arise in the fluid flow, the wall thickness of the damping housing is configured to be reinforced with respect to the wall thickness of the damping tube.
